(19) United States
(12) Patent Application Publication
(10) Pub. No.: US 2017/0237794 A1
(43) Pub. Date: Aug. 17, 2017

(54) TECHNOLOGIES FOR DISTRIBUTED FAULT-TOLERANT TRANSCODING WITH SYNCHRONIZED STREAMS

(71) Applicant: Magine Holding AB, Stockholm (SE)

(72) Inventors: Ano Jarvi, Turku (FI); Pekka Heino, Turku (FI); Thommy Eklof, Ingaro (SE)

(21) Appl. No.: 15/042,810

(22) Filed: Feb. 12, 2016

(51) Int. Cl. H04L 29/06

(52) U.S. Cl. CPC H04L 65/607; H04L 67/42

(57) ABSTRACT

A method includes receiving, via an input service running on a server, a transcoding request from a client, the transcoding request requesting a segment of digital content, the transcoding request containing a start time of the segment and a duration of the segment; requesting, via the input service, the segment from a source based on the transcoding request; receiving, via the input service, the segment and metadata from the source based on the requesting, the metadata being related to the start time and the duration; transcoding, via the input service, the segment based on the metadata in the transcoder service; and sending, via the input service, the segment from the transcoder service to the client based on the transcoding.

### TECHNICAL FIELD

Generally, the present disclosure relates to computing. More particularly, the present disclosure relates to network-based content or media processing.

### BACKGROUND

In the present disclosure, where a document, an act and/or an item of knowledge is referred to and/or discussed, then such reference and/or discussion is not an admission that the document, the act and/or the item of knowledge and/or any combination thereof was at the priority date, publicly available, known to the public, part of common general knowledge and/or otherwise constitutes prior art under the applicable statutory provisions; and/or is known to be relevant to an attempt to solve any problem with which the present disclosure is concerned with. Further, nothing is disclaimed.

Technologies used in content streaming over uncontrolled network environments, such as the Internet or other networks, generally use adaptive bitrate, where the content is transcoded into multiple bitrates for coping with changing network conditions, which are often difficult to anticipate. For example, lower bitrates provide uninterrupted playback over a poor network connection, but sacrifice on quality, while higher bitrates provide better quality, but are difficult to transfer over a poor network connection. Accordingly, various protocols, which employ the adaptive bitrate technology, are available to automatically increase or decrease current streaming bitrate based on changing network conditions.

At the server-end, different qualities are generally synchronized in order to avoid glitches during client playback when bitrate adaptation occurs. Using current technology, such processing typically means that many, if not most or all, qualities for a stream tend to be encoded in a single computing unit, which can degrade a performance of the single computing unit. Also, using commodity computing hardware, there is a limited maximum quality and number of qualities a single computing unit can handle in real-time, without a significant degradation in performance.

Moreover, live television signal processing is often unreliable, such when signal delivery is via satellites, and there is generally one opportunity to capture all relevant incoming material. An inability to take advantage of this opportunity can affect various aspects of network-based content or media processing, especially because most current tools used for media transcoding are generally not redundant in case of inevitable failures. When such failures happen, frequently, a large amount of data can be permanently lost, which can be frustrating or sometimes commercially catastrophic.

Current protocols and client implementations used for network-based live streaming are still in early stages of development and many types of errors can occur. Such errors can lead to interruption of network-based content playback, which reduces customer satisfaction.

### BRIEF SUMMARY

The present disclosure at least partially addresses at least one of the above. However, the present disclosure can prove useful to other technical areas. Therefore, the claims should not be construed as necessarily limited to addressing any of the above.

In an embodiment, a method comprises receiving, via an input service running on a server, a transcoding request from a client, the transcoding request requesting a segment of digital content, the transcoding request containing a start time of the segment and a duration of the segment; requesting, via the input service, the segment from a source based on the transcoding request; receiving, via the input service, the segment and metadata from the source based on the requesting, the metadata being related to the start time and the duration; transcoding, via the input service, the segment based on the metadata in the transcoder service; and sending, via the input service, the segment from the transcoder service to the client based on the transcoding.

In an embodiment, a system comprises a server configured to: receive, via an input service, a transcoding request from a client, the transcoding request requesting a segment of digital content, the transcoding request containing a start time of the segment and a duration of the segment; request, via the input service, the segment from a source based on the transcoding request; receive, via the input service, the segment and metadata from the source based on the requesting, the metadata being related to the start time and the duration; transcode, via the input service, the segment based on the metadata in the transcoder service; and send, via the input service, the segment from the transcoder service to the client based on the transcoding.

Additional features and advantages of various embodiments are set forth in the description which follows, and in part is apparent from the description. Various objectives and other advantages of the present disclosure are realized and attained by various structures particularly pointed out in the exemplary embodiments in the written description and claims hereof as well as the appended drawings. It is to be understood that both the foregoing general description and the following detailed description are exemplary and explanatory and are intended to provide further explanation of the present disclosure as claimed.

### BRIEF DESCRIPTION OF THE DRAWINGS

The accompanying drawings constitute a part of this specification and illustrate an embodiment of the present disclosure and together with the specification, explain the present disclosure.

FIG. 1 shows a schematic view of an example embodiment of a computer network model according to the present disclosure.

FIG. 2 shows a schematic view of an example embodiment of a transcoding system according to the present disclosure.

FIG. 3 shows a diagram of an example embodiment of a segmentation of an incoming media stream according to the present disclosure.

FIG. 4 shows a diagram of an example embodiment of a transcoding chain handing a plurality of types of content according to the present disclosure.

FIG. 5 shows a diagram of an example embodiment of a portion of a transcoding chain according to the present disclosure.

FIG. 6 shows a diagram of an example embodiment of a network architecture according to the present disclosure.

### DETAILED DESCRIPTION OF THE PREFERRED EMBODIMENTS

The present disclosure is now described more fully with reference to the accompanying drawings, in which example embodiments of the present disclosure are shown. The present disclosure may, however, be embodied in many different forms and should not be construed as necessarily being limited to the example embodiments disclosed herein. Rather, these example embodiments are provided so that the present disclosure is thorough and complete, and fully conveys the concepts of the present disclosure to those skilled in the relevant art.

Features or functionality described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity or actor in any manner.

The terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from the teachings of the present disclosure.

The terminology used herein is for describing particular example embodiments and is not intended to be necessarily limiting of the present disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence and/or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Generally, the present disclosure relates to transcoding, segmentation, encryption, and metadata and any provisional storage for live content/material and video on demand (VOD) content/material, such as live digital TV, where video, audio, and subtitles can be distributed or requested on demand from a network-based providing side, such as when requested by a network client. Such functionality is provided by a whole transcoding chain being initiated and driven by a server-based requester service to initiate a transcoding job and deliver a content segment, rather than a transcoding process being driven by a server-based input service. Resultantly, based on a configuration for a network-based requester, on demand transcoding of live content and VOD content can be provided, such as via network-based streaming, for example, by way of a client browser or a browser plug-in or a browser extension programmed to output such content.

For example, when such functionality is provided through a network-based pull model, then the pull model allows for transcoding to happen when a customer, such as an end user, is actually watching or otherwise accessing a network-based content stream. Further, such manner of transcoding, especially with media having a disallowed time shifting functionality, enables content delivery to a customer without storage, thereby eliminating or reducing storage resources or costs. Likewise, such manner of transcoding preserves, reduces, or efficiently manages server resources since no client-requested transcoding transaction occurs because there is no transcoding if no customer is consuming a content stream.

Since present transcoding techniques employed for transcoding live content and VOD content are resource intensive and financially costly, especially where a real-time aspect of content is important or includes a transcoding of a large number of output qualities, such as two pass encoding, the present disclosure enables various transcoding solutions and transcoding techniques, which are cost-efficient and can be distributed over multiple computing units in a synchronized manner. These configurations combined with a usage of various interfaces, such as a Hypertext Transfer Protocol (HTTP) interface, enable a high-availability content distribution framework on top of a solution using common computing technologies.

Further, in software and/or hardware failure situations, such framework can be made to fallback into any number of different failover strategies, such as trying a different software implementation or using a spare computing unit, possibly without losing any data or with minimum data losses. In case of small packet loss or such, previously received data can be used to fix or fill one or more gaps, such as via duplicating video frames. If, for some reason, a real segment cannot be served to a client, then a pre-encoded filler segment can be processed or generated to replace a missing segment, at least temporarily, where the pre-encoded filler segment can be programmed to optionally contain information informative of a reason or a problem why the real segment cannot be served to the client and such information can be accessible to a user, whether on client side or server side. For example, such processing can comprise multiplexing or encapsulating a single type of media into a streaming protocol's standard container format. In some embodiments, a separate segmenter is absent, but a requester is responsible to decide a quality and a time range of a piece of media at hand. However, note that there can be more than one requester per media stream, such as one for each streaming protocol. Since requested time ranges from a transcoder can vary, a transcoder can be responsible for deciding how much content the transcoder should transcode in one run or a transcoding instance or a session, but the transcoder only returns a request range back to a requester and for example, a remaining amount can be cached in a cache. Accordingly, the requester provides maximum flexibility in terms of content provision, such as via allowing a first requester to request a segmented stream and a second requester to request a single file media stream, where one large media file includes a whole program. Further, note that requested ranges can be future-based, where a whole transcoding chain is waiting until content is available from an input service. In such configurations, the input service is content-agnostic, i.e., a content time stamp, such as byte array map.

Moreover, one more transcoding techniques disclosed in the present disclosure can reduce or remove a need for real-time transcoding by segmenting ingested material early and processing such segmented material in parallel, where a starting position of client playback is intentionally delayed so that many, most, or all, of such segments are available when requested.

Note that distribution of live material or VOD material, such as television programming, over a packet-based computer network, such as the Internet or other networks, whether of packet type or non-packet type, can be performed adaptively by providing multiple bitrates of same content to be used over changing network conditions based on changing consumed bitrate automatically in accordance with available resources, such as network resources or available bandwidth. Such operations allow seamless playback in poor network conditions or poor network connections. In such network environments, content can be delivered as small, downloadable pieces, which can include or are segments, and a network stream includes at least one of video, audio, or subtitles or any combination of those.

Note that alternate content can be provided for different languages, locations, audiences, input device or output device configurations or orientations, camera angles, or other versions, such as for people with one or more disabilities. Such content can also be transcoded at multiple bitrates for use with adaptive bitrate streaming. For example, transcoding at one bitrate can include multiple ordered operations, such as a chain or a sequence, transforming an input material to achieve a target quality.

Note that different playback systems support different streaming protocols and different digital rights management (DRM) solutions. Therefore, in order to provide support for wide range of playback systems, content can be convertible to or between multiple formats. Content can be delivered through a content delivery network (CDN) for efficient use of network resources and one or more live streams can be delivered on demand or recorded to intermediate storage, such as volatile memory or a non-volatile storage.

Note that a transcoding chain can comprise a chain of transformations, which modify content from one characteristic/format/size/quality to another. Transformations may be, and often are, destructive.

Note that a live content source can comprise a source of content which is currently streaming. For example, the live content source can comprise a single TV channel stream.

Note that a live delay can comprise a delay before a media arrives at an input of a transcoding chain, such as a delay used by a broadcaster to allow for content censoring or a delay between input of live content into the transcoding processing an the time the content is available for viewing on a client. The latter delay can include at least one of a processing time in the transcoding chain, a time of transport of the content to the client, or a default or a minimum required cached time period in a content player of the client. For example, when the content comprises video, then such delay can comprise a delay between a frame entering into a transcoding chain until the frame is displayed/rendered or otherwise output on or to the client.

Note that a synchronized or a raw segment can comprise a chunk of data, which represents a representation, which is not necessarily perfect, of what was distributed from a live content source between at least two timestamps, such as points in time. The synchronized or the raw segment can comprise at least one of audio, video, subtitles or metadata that may change during a course of processing in an transcoding chain.

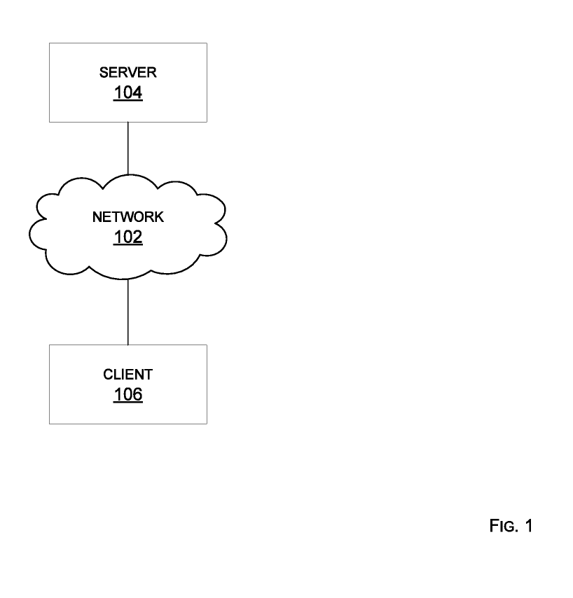

FIG. 1 shows a schematic view of an exemplary embodiment of a computer network model according to the present disclosure. A computer network model 100 comprises a network 102, a server 104, and a client 106. Such distributed operation model allocates tasks/workloads between the server 104, which provides a resource/service, and the client 106, which requests the resource/service. The server 104 and the client 106 illustrate different computers/applications, but in other embodiments, the server 104 and the client 106 reside in or are one system/application. Further, in some embodiments, the model 100 entails allocating a large number of resources to a small number of computers, such as the servers 104, where complexity of the client 106 depends on how much computation is offloaded to the number of computers, i.e., more computation offloaded from the clients 106 onto the servers 104 leads to lighter clients 106, such as being more reliant on network sources and less reliant on local computing resources.

The network 102 includes a plurality of nodes, such as a collection of computers and/or other hardware interconnected via a plurality of communication channels, which allow for sharing of resources and/or information. Such interconnection can be direct and/or indirect. The network 102 can be wired and/or wireless. The network 102 can allow for communication over short and/or long distances, whether encrypted and/or unencrypted. The network 102 can operate via at least one network protocol, such as Ethernet, a Transmission Control Protocol (TCP)/Internet Protocol (IP), and so forth. The network 102 can have any scale, such as a personal area network, a local area network, a home area network, a storage area network, a campus area network, a backbone network, a metropolitan area network, a wide area network, an enterprise private network, a virtual private network, a virtual network, a satellite network, a computer cloud network, an internetwork, a cellular network, and so forth. The network 102 can be and/or include an intranet and/or an extranet. The network 102 can be and/or include Internet. The network 102 can include other networks and/or allow for communication with other networks, whether sub-networks and/or distinct networks, whether identical and/or different from the network 102 in structure or operation. The network 102 can include hardware, such as a computer, a network interface card, a repeater, a hub, a bridge, a switch, an extender, an antenna, and/or a firewall, whether hardware based and/or software based. The network 102 can be operated, directly and/or indirectly, by and/or on behalf of one and/or more entities or actors, irrespective of any relation to contents of the present disclosure.

The server 104 can be hardware-based and/or software-based. The server 104 is and/or is hosted on, whether directly and/or indirectly, a server computer, whether stationary or mobile, such as a kiosk, a workstation, a vehicle, whether land, marine, or aerial, a desktop, a laptop, a tablet, a mobile phone, a mainframe, a supercomputer, a server farm, and so forth. The server computer can include and/or be a part of another computer system and/or a cloud computing network. The server computer can run any type of operating system (OS), such as MacOS®, Windows®, Android®, Unix®, Linux® and/or others. The server computer can include and/or be coupled to, whether directly and/or indirectly, an input device, such as a mouse, a keyboard, a camera, whether forward-facing and/or back-facing, an accelerometer, a touchscreen, a biometric reader, a clicker, and/or a microphone. The server computer can include and/or be coupled to, whether directly and/or indirectly, an output device, such as a display, a speaker, a headphone, a joystick, a videogame controller, a vibrator, and/or a printer. In some embodiments, the input device and the output device can be embodied in one unit. The server computer can include circuitry for global positioning determination, such as via a global positioning system (GPS), a signal triangulation system, and so forth. The server computer can be equipped with near-field-communication (NFC) circuitry. The server computer can host, run, and/or be coupled to, whether directly and/or indirectly, a database, such as a relational database or a non-relational database, such as a post-relational database, an in-memory database, or others, which can feed or otherwise provide data to the server 104, whether directly and/or indirectly. For example, the server 104 functions as a content provider.

The server 104, via the server computer, is in communication with the network 102, such as directly and/or indirectly, selectively and/or unselectively, encrypted and/or unencrypted, wired and/or wireless. Such communication can be via a software application, a software module, a mobile app, a browser, a browser extension, an OS, and/or any combination thereof. For example, such communication can be via a common framework/application programming interface (API), such as Hypertext Transfer Protocol Secure (HTTPS).

The client 106 can be hardware-based and/or software-based. The client 106 is and/or is hosted on, whether directly and/or indirectly, a client computer, whether stationary or mobile, such as a terminal, a kiosk, a workstation, a vehicle, whether land, marine, or aerial, a desktop, a laptop, a tablet, a mobile phone, a mainframe, a supercomputer, a server farm, and so forth. The client computer can include and/or be a part of another computer system and/or cloud computing network. The client computer can run any type of OS, such as MacOS®, Windows®, Android®, Unix®, Linux® and/or others. The client computer can include and/or be coupled to an input device, such as a mouse, a keyboard, a camera, whether forward-facing and/or back-facing, an accelerometer, a touchscreen, a biometric reader, a clicker, and/or a microphone, and/or an output device, such as a display, a speaker, a headphone, a joystick, a videogame controller, a vibrator, and/or a printer. In some embodiments, the input device and the output device can be embodied in one unit. The client computer can include circuitry for global positioning determination, such as via a GPS, a signal triangulation system, and so forth. The client computer can be equipped with NFC circuitry. The client computer can host, run and/or be coupled to, whether directly and/or indirectly, a database, such as a relational database or a non-relational database, such as a post-relational database, an in-memory database, or others, which can feed or otherwise provide data to the client 106, whether directly and/or indirectly. For example, the client 106 functions as a content consumer.

The client 106, via the client computer, is in communication with network 102, such as directly and/or indirectly, selectively and/or unselectively, encrypted and/or unencrypted, wired and/or wireless, via contact and/or contactless. Such communication can be via a software application, a software module, a mobile app, a browser, a browser extension, an OS, and/or any combination thereof. For example, such communication can be via a common framework/API, such as HTTPS.

In other embodiments, the server 104 and the client 106 can also directly communicate with each other, such as when hosted in one system or when in local proximity to each other. Such direct communication can be selective and/or unselective, encrypted and/or unencrypted, wired and/or wireless, via contact and/or contactless. Since many of the clients 106 can initiate sessions with the server 104 relatively simultaneously, in some embodiments, the server 104 employs load-balancing technologies and/or failover technologies for operational efficiency, continuity, and/or redundancy.

Note that other computing models are possible as well. For example, such models can comprise decentralized computing, such as peer-to-peer (P2P) or distributed computing, such as via a computer cluster where a set of networked computers works together such that the computer can be viewed as a single system.

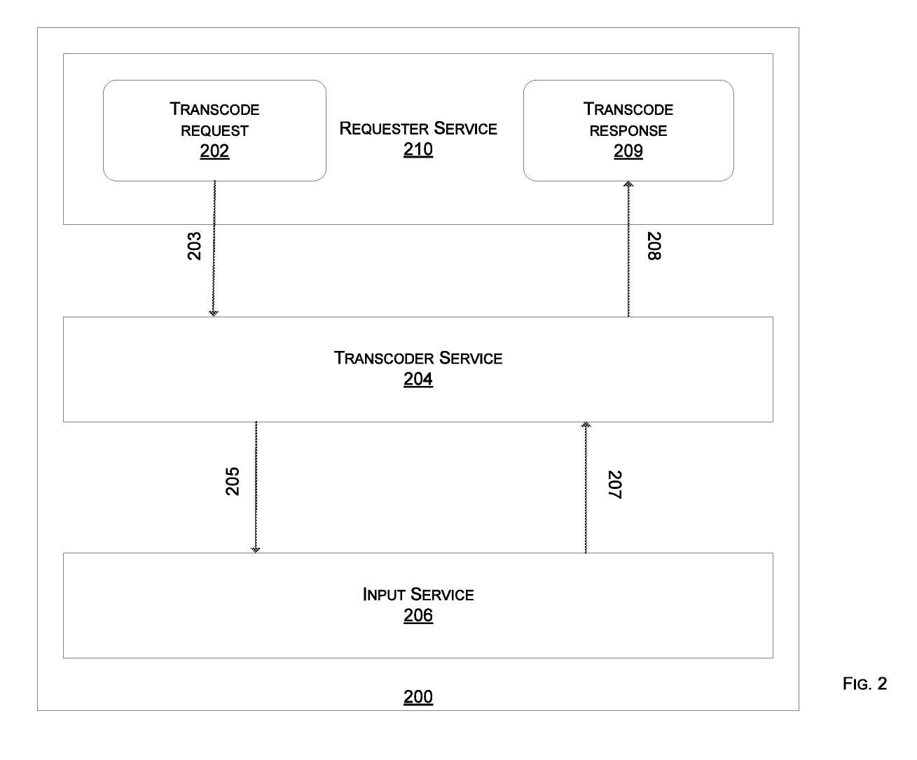

FIG. 2 shows a schematic view of an example embodiment of a transcoding system according to the present disclosure. A transcoding system 200 is at least able to spread or distribute a workload of a single, possibly composite, media stream between different networked computers, such as shown in FIG. 1. For example, the transcoding system can be hosted on the server 104 to serve the client 106. The transcoding system 200 spreads or distributes such workload via splitting an incoming content into a plurality of smaller parts and processing such parts in a load-balanced manner in multiple transcoding instances. The transcoding system 200 comprises a requester service 210, a transcoder service 204, and an input service 206.

At least one of the requester service 210, the transcoder service 204, or the input service 206 can be implemented in logic, whether hardware-based or software-based. For example, when the logic is hardware-based, then such logic can comprise circuitry, such as processors, memory, input devices, output devices, or other hardware, that is configured, such as via programming or design, to implement a functionality of least one of the requester service 210, the transcoder service 204, or the input service 206. Likewise, when the logic is software-based, then such logic can comprise one or more instructions, such as assembly code, machine code, object code, source code, or any other type of instructions, which when executed, such as via running or compilation, implement a functionality of at least one of the requester service 210, the transcoder service 204, or the input service 206 service 206. For example, at least one of the requester service 210, the transcoder service 204, or the input service 206 can be implemented as a service. Note that at least two of the requester service 210, the transcoder service 204, or the input service 206 can be hosted on one computing system or each be distinctly hosted.

The requester service 210 is at least configured, such as via programming or design, to receive a transcode request 202, to send the transcode request 202 to the transcoder service 204, and to receive a transcode response 209. For example, the requester service 210 can function as a communication service. Optionally, the requester service 210 can be configured to send or otherwise forward the transcode response 209 to a logic implementation, whether hardware-based or software-based, whether local to or remote from the requester service 210, as described herein, such as circuitry, such as processors, memory, input devices, output devices, other hardware, and/or one or more instructions, such as assembly code, machine code, object code, source code, any other type of instructions, which when executed, such as via running or compilation, implement a functionality. The requester service 210, such as a transceiver, can receive the transcode request 202 over a network in a wireless or wired manner from another device, whether local to or remote from the requester service 210, such as a mobile phone or a tablet computer. The requester service 210, such as an integrated circuit, can also receive the transcode request 202 from a hardware component of a computer coupled to the requester service 210, such as via a system bus. The requester service 210, such as a software module or an application, can also receive the transcode request 202 from a software application, whether running local to or remote from the requester service 210, such as a media player on a vehicle computer. The transcoding request 209 requests a transcoding operation for at least a portion of media, such as video, audio, subtitles, or any combinations thereof. The requester service 210 receives the transcode response 209 from the transcoder service 204.

The requester service 210 operates as, includes, or is a requester service. Accordingly, the requester service 210 can initiate a transcoding job and serve or store one or more results of such job, such as on a volatile or a non-volatile storage. The requester service 210 can be embodied in, include, or operate as multiple requesters running for a same live streaming source. Requester service 210 can save one or more results for later use or act as a web server processing content for different streaming protocols, such as via multiplexing or via encapsulating a single type of media into a streaming protocol's standard container format. The requester service 210 can also operates as, include, or be a monitoring system that keeps a live transcoding process running. The requester service 210 can also be configured in such a manner as to allow a chain or a train of requester services 210 so that a first requester service 210 is monitoring different streaming protocol processes, a second requester service 210 is uploading various outputs from such processes to one or more storage servers, and a third requester service 210 is starting one or more transcoding jobs and packaging to a requested container form at and DRM system.

The transcoder service 204 is at least configured, such as via programming or design, to receive the transcode request 202 from the requester service 210, to perform one or more operations based on the transcode request 202, such as processing the transcode request 202, to send a data request to the input service 206 in accordance with one or more operations on the transcode request 202, to receive the requested data from the input service 206, to transcode the requested data, and to send the transcode response 209 to the requester service 210 based on transcoding the requested data. The transcoder service 204, such as a hardware chip/circuit or a software module/object, can receive the transcode request 202 over a network in a wireless or wired manner from another device, whether local to or remote from the transcoder service 204, such as a mobile phone or a tablet computer. The transcoder service 204, such as an integrated circuit or a software routine, can also receive the transcode request 202 from a hardware component of a computer coupled to the transcoder service 204, such as via a system bus. The transcoder service 204, such as a software module, an object, a routine, or an application, can also receive the transcode request 202 from a software application, whether running local to or remote from the transcoder service 204, such as a media player on a vehicle computer or a network client.

The transcoder service 204 handles a conversion to a requested output encoding and quality. A needed part of an input material is requested from the input service 206. A filter chain is formed based on an available input material and requested output configuration. One or more steps in the transcoding chain can then be executed, where one or more of intermediate results can be cached in a memory, whether local to or remote from the transcoder 206, and used again when one or more following transcoding jobs are using same input data. Note that the transcoder service 204 can comprise or be coupled to a configured amount of memory to cache intermediate results and least recently used items can be cleaned to respect memory limits. The transcoder service 204 can use consistent hashing in a load balancer when selecting a transcoder for better cache hits. Also, note that a process of transcoding live content should be able to keep up with generating an output format(s) in real time; otherwise a presumptive user can experience stops/glitches while watching live material, since material will otherwise at some point not be available. Further, note that keep up with does not necessarily mean that transcoding at a certain quality with some specific source media and at a certain bandwidth is possible in real time on a single computing unit of today: by introducing live delay times in combination with parallel processing, one or more technologies disclosed herein enable a delivery of higher qualities than can be encoded on today's generic central processing units (CPU) cores in real time, at a cost of delay from a source signal. For example, a client and/or an end user can choose to watch or otherwise access a lower quality stream of content with minimal delay to an actual broadcast, when another client and/or end user might choose a better quality stream, which has more delay, and includes the lower quality stream as part of adaptive bitrate streaming.

The input service 206 is at least configured, such as via programming or design, to receive the data request from the transcoder service 204, to retrieve an amount of an input content, such as a segment, based on the data request, whether the input content is locally or remotely hosted in memory, and provide the requested data, such as a segment, with additional timing related metadata for one or more requested time ranges to the transcoder service 204 such that the transcoder service 204 is able to transcode the requested data for returning the transcoded requested data to the requester service 210. The input service 206, such as a as a hardware chip/circuit or a software module/object, can receive the data request over a network in a wireless or wired manner from another device, whether local to or remote from the input service 206, such as a mobile phone or a tablet computer. The input service 206, such as an integrated circuit or a software routine, can also receive the data request from a hardware component of a computer coupled to the input service 206, such as via a system bus. The input service 206, such as a software module, an object, a routine, or an application, can also receive the data request from a software application, whether running local to or remote from the input server, such as a content player on a vehicle computer.

The input service 206 operates as, includes, or is an input service, which receives, stores, or otherwise accesses source material and serves one or more parts of the requested source material to one or more transcoders 206. The source material can operate as, include, or be a static file or a continuous stream. The input service 206 can implement a minimal input processing to be able to serve one or more of the parts to one or more transcoding jobs on the one or more transcoders 206. Note that when more than one input service 206 is used, then the input servers 206 can share information about running sources and redirect transcoders 206 to the input servers 206 where source is already running. Note that new source material/stream is automatically opened when the new source material/stream is not already handled by configured amount of input services. Further, note that at least some of streamed input material can be cached so that one or more transcoding operations of the one or more transcoders 206 can be completed also when several attempts are needed, if at all. Moreover, note that sources are closed when not used for configured time.

Resultantly, the transcoding system 200 is able to support a whole transcoding chain, where an output of such chain includes one or more segments of video, audio, or subtitles. For each output segment, the requester service 210 sends the transcode request 202 to the transcoder service 204, as disclosed herein. Such sending is indicated by a label 203. Such sending can be responsive to or triggered by a request received by the requester service 210 from a client remote from the requester service 210, such as the client 106 of FIG. 1. Upon receipt of the transcode request 202 from the requester service 210 by the transcoder service 204, for each transcoding operation, the transcoder service 204 sends a data request, which requests a part of an input stream, such as a segment, to the input service 206, as disclosed herein. Such sending is indicated by a label 205. Such sending can be responsive to or triggered by a request received by the transcoder service 204 from the requester service 210. Note that the transcode request 202 contains information informative of the segment's start time and duration, which can be calculated outside of the whole transcoding chain, which can be beneficial because there is no real segmenter, but a segmentation is performed as a part of creating the transcode request 202. Since the input service 206 stores or otherwise has access to some amount of an input stream, such as in an internal memory cache, upon receipt of the requested data from the transcoder service 204 by the input service 206, the input service 206 provides the requested data, such as a segment, with additional timing related metadata for one or more requested time ranges to the transcoder service 204, as disclosed herein. Such provision is indicated by a label 207. Upon receipt of the requested data and the additional timing related metadata for one or more requested time ranges by the transcoder service 204 from the input service 206, the transcoder service 204 transcodes the requested data, as disclosed herein. Upon transcoding of the requested data by the transcoder service 204, the transcoder service 204 returns the transcoded requested data to the requester service 210 as the transcode response 209, as disclosed herein. Such return is indicated by a label 208.

The transcoding system 200 can be based on one or more components acting as one or more HTTP servers, where the one or more components can find each other by service discovery. For example, the one or more components comprise at least one of the requester service 210, the transcoder service 204, or the input service 206. A network architecture of the transcoding system 200 is pull model based, although other models can also be used, whether additionally or alternatively, such as a push-model. For example, when the architecture of the transcoding system 200 is pull model based, such configuration enables a delivery of results in a fast, scalable, or reliable manner. For example, the requester service 210 initiates a transcoding process by requesting content from the transcoder service 204. If the transcoder service 204 does not yet have that material, then the transcoder service 204 will request that material from the input service 206. Once the transcoder service 204 starts receiving the input material from the input server, the transcoder service 204 can start to deliver an output material to the requester service 210. Since multiple computing entities, such as servers, can be used for one or more of the input service 206, the transcoder service 204, or the requester service 210, a fallback can exist to ensure a reliable operation in case of server crash or a computing entity malfunction. Likewise, for scalability purposes, resources to one or more groups, such as the input service 206, the transcoder service 204, or the requester service 210, can be adjusted on demand, such as via addition or removal and an unlimited number of qualities per channel can be used since there is no longer a need to manage transcoders, per channel.

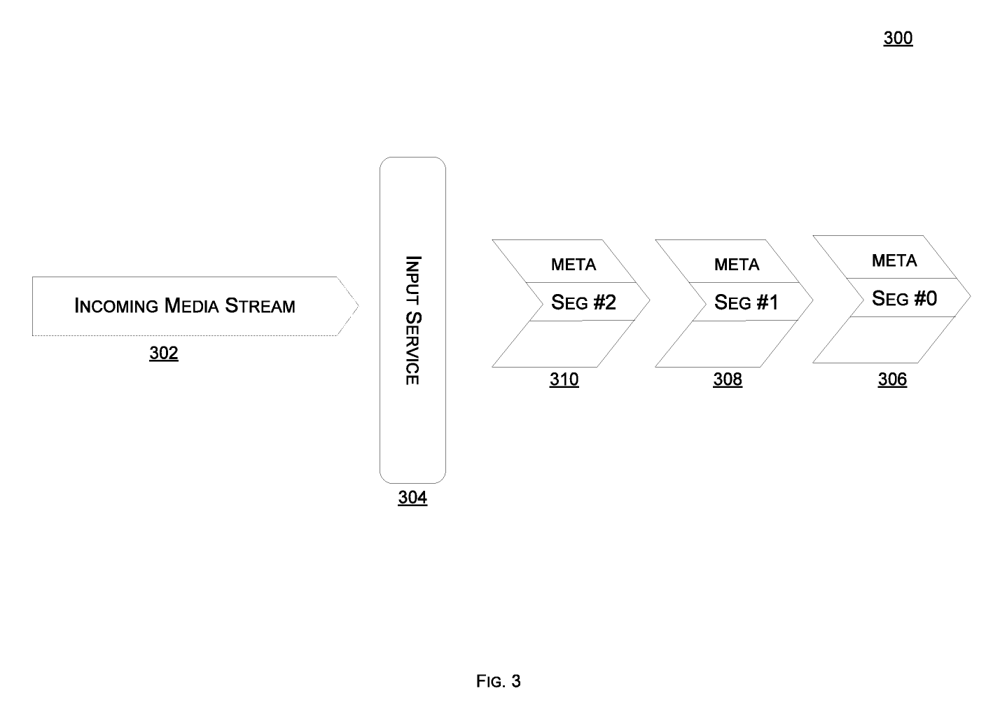

FIG. 3 shows a diagram of an exemplary embodiment of a segmentation of an incoming content stream according to the present disclosure. The transcoding system 200 is at least able to spread or distribute a workload of a single, possibly composite, content stream between different networked computers, such as shown in FIG. 1. The transcoding system 200 spreads or distributes such workload by splitting a transcoding process of a content stream into a plurality of smaller parts and processing such parts in a load-balanced manner in multiple transcoding instances. Such splitting can be performed by segmenting an input stream early and preserving metadata about each resulting segment and its relation to time and neighboring segments. Such segmentation and preservation can be performed via a segmentation process 300, which entails receiving an incoming media stream 302 by an input service 304, such as the transcoder service 204 or the input service 206. For example, the input service 304 can comprise, be a part of, or is a Widevine® DRM system, which can segment a transcoded signal into a plurality of segments, such as about 2 seconds of content per segment, and wrap at least one such segments into a DRM protective cover. However, note that other DRM systems can be used, whether additionally or alternatively, such as Microsoft PlayReady®, Apple FairPlay®, or others. The segmentation process 300 further entails the input service 304 segmenting the incoming media stream 302 into a plurality of segments 306, 308, 310. Each of the segments 306, 308, 310 includes a content portion, such as video, audio, subtitles, or any combination thereof, and a metadata portion, such as time, size, order in sequence, or other relevant data, as disclosed herein. Note that the input service 304 can return the content as is. Also, the transcoder service 204 can process the content, such as via de-multiplexing or de-encapsulating, as disclosed herein, and is responsible for reading all relevant metadata from the stream 302.

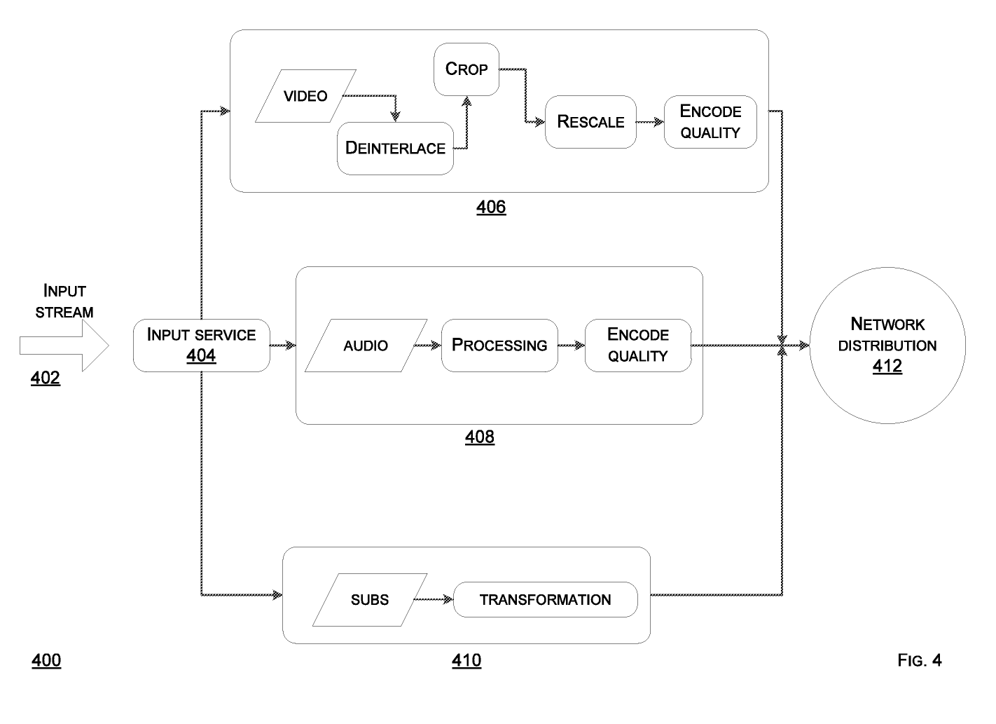

FIG. 4 shows a diagram of an exemplary embodiment of a transcoding chain handing a plurality of types of content according to the present disclosure. The transcoder service 204 handles a conversion to a requested output encoding and quality. A needed part of an input material is requested from the input service 206. A filter chain is formed based on an available input material and requested output configuration. One or more steps in the transcoding chain can then be executed, where one or more of intermediate results can be cached in a memory, whether local to or remote from the transcoder 206, and used again when one or more following transcoding jobs are using same input data.

Note that the transcoder service 204 can comprise or be coupled to a configured amount of memory to cache intermediate results and least recently used items can be cleaned to respect memory limits. Accordingly, an input stream 402, such as the incoming media stream 302, is received and segmented, as indicated by a block 404, into a plurality of segments. Each of the segments includes at least one of a video content, an audio content, or a subtitle content. Video, audio and subtitles are all chains of quality outputs. For example, the audio chain output one as that chain is multiplied per quality. Each of the segments is processed according to a content type, such as encoding. For example, the video content of the segment is processed in a block 406, the audio content of the segment is processed in a block 408, and the subtitle content of the segment is processed in a block 410. For example, in the block 408, the audio content is processed before an output of an encode quality. Such audio signal processing can comprise digital signal processing and can comprise equalization, resampling, volume normalization, filtering, synthesizing, modulation, compression, or any other type of audio signal processing. Upon completion of such processing, for each of the segments, content is joined and subsequently distributed in a network distribution manner, as indicated by a block 412. Therefore, different content types are handles in different processing chains. However, note that there can be multiple sequential transcoding operations and those intermediate results can be cached for future needs, where a transcoding operation can comprise any operation about or related to handling content.

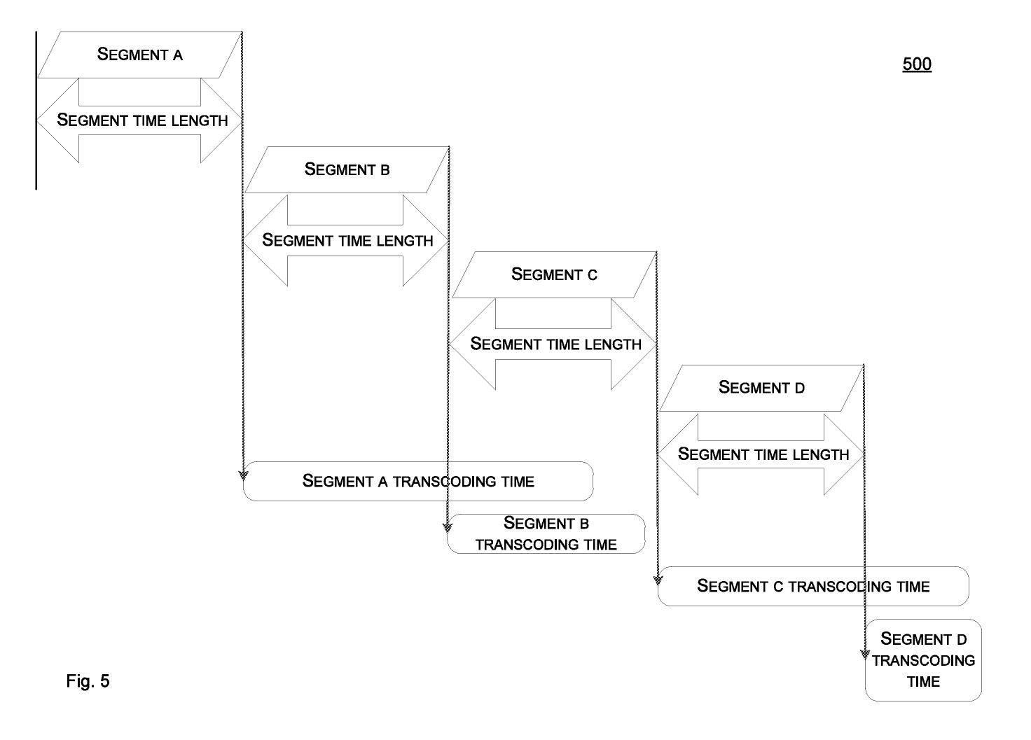

FIG. 5 shows a diagram of an exemplary embodiment of a portion of a transcoding chain according to the present disclosure. A portion 500 of a transcoding chain includes a segment A, a segment B, a segment C, and a segment D, with each of such segments having a respective segment content length, whether identical to or different from each other. The transcoding chain can include a plurality of transformations of content in a chain of transformation tasks. The transformations can comprise one or more intermediate content representations between each of the transformations, but not necessarily. Such representations and their compression/size can differ, which can be large. For example, uncompressed segments, that exist between decoding of an input media and encoding to an output format can be large and in some scenarios are impractical to shuffle around except with a memory of a computer while processing. Accordingly, practical matters, like such scenarios, can define and place limits on how a distribution of a workload can be implemented to be practically feasible for live content such as live TV.

Note that in the portion 500, a difference exists between a segment length and a transcoding time. In particular, the transcoding time of the segment A and the segment C are noticeably longer than the segment length of each of the segment A, the segment B, the segment C, and the segment D. Likewise, note that processing time of different segments from a same stream can vary depending on a content and how taxing the processing is to decode, transform, and encode. Similarly, note that the transcoding of segments can happen in parallel.

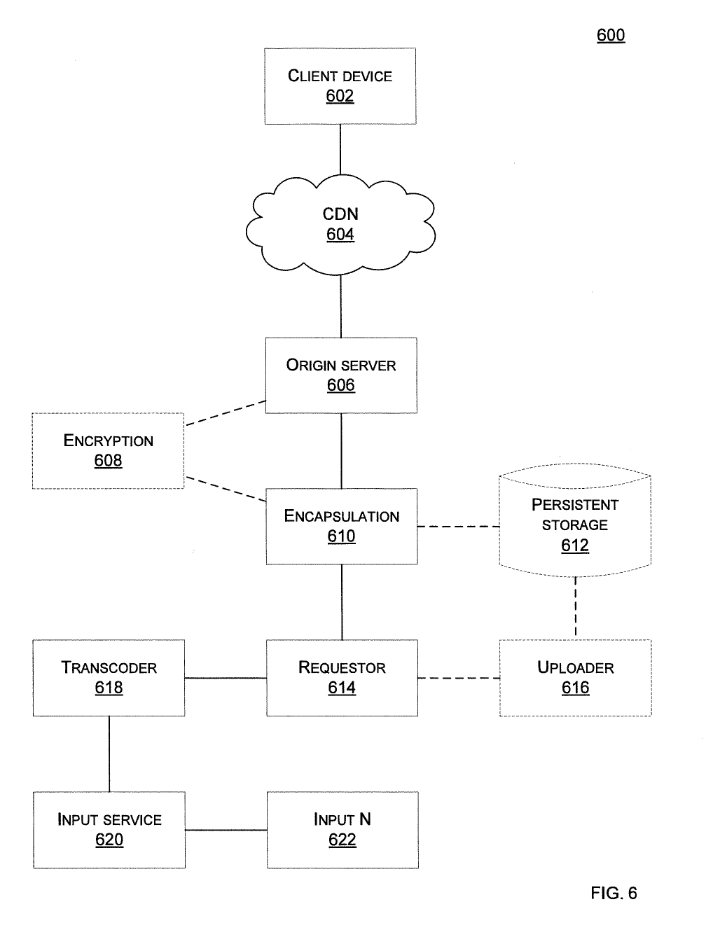

FIG. 6 shows a diagram of an exemplary embodiment of a network architecture according to the present disclosure. A network architecture 600 includes a client device 602, a CDN 604, an origin server 606, an encryption unit 608, a encapsulation unit 610, a persistent storage 612, a requestor 614, an uploader 616, a transcoder 618, an input service 620, and an input device 622. Each of such components is in signal communication as shown in FIG. 6. Such signal communication can be wired or wireless, direct or indirect. Note that the encryption unit 608, the persistent storage 612, or the uploader 616 are optional and, in some embodiments, the encryption unit 608, the persistent storage 612, or the uploader 616 can be excluded from functioning, disabled, or omitted within or from the network architecture 600, as disclosed herein. Note each of components can be implemented in logic, whether hardware-based or software-based. For example, when the logic is hardware-based, then such logic can comprise circuitry, such as processors, memory, input devices, output devices, or other hardware, that is configured, such as via programming or design, to implement a functionality of a respective component. Likewise, when the logic is software-based, then such logic can comprise one or more instructions, such as assembly code, machine code, object code, source code, or any other type of instructions, which when executed, such as via running or compilation, implement a functionality of a respective component. Further, note that at least one of such components can be implemented as a service. Moreover, note that at least two of such components can be hosted on one computing system/hardware/device or each be distinctly hosted.

Generally, a set of servers used for processing material from the input device 622 to the requester 614 operates as, includes, or is a pipeline. Therefore, at least a portion of pipeline information can be recorded when a material is transferred between components of the architecture 600. The requester 614 can include a last received pipeline information with at least one following request. The components of the architecture 600 can place requests from one or more servers specified in the pipeline information, where one or more of such servers can attempt to start serving requested content as soon as possible. For operational efficiency, one of more of such servers can limit concurrently processed requests to ensure that processing or storage resources are not overused. The architecture 600 employs a server running at least one of each of components types. However, the architecture 600 can be configured in other arrangements, such as the server running at least two of each of component types. For example, to start transcoding of a channel, a media player can be started or activated. Next, the media player can request a playlist from a requester server, such as the requester 614. The requester server can create a suitable playlist for a client, such as the client device 602, with many, most, or all predictable segments. Then, the client can start to play a stream by requesting segments through the requester server. Next, the requester server can return one or more segments from a memory cache or trigger one or more new transcoding jobs. The transcoder, such as the transcoder 618, can requests content from the input server, such as the input service 620, which starts to receive the stream. Transcoding can automatically stops as soon as the media player is stopped. Note that the requester server can create playlists and request, multiplex, encapsulate a single type of media into a streaming protocol's standard container format, cache, and serve transcoding results.

In particular, the origin server 606 serves one or more content segments to the CDN 604. For example, the CDN 604 can comprise, be a part of, or is at least one of an Akamai Technologies® network, a Limelight Networks® network, an Amazon CloudFront® network, an EdgeCast® network, or a Level 3 Communications® network. The one or more content segments can be encrypted by the encryption unit 608 after encapsulation by the encapsulation unit 610 before the origin server 606 serves the one or more content segments to the CDN 604. For example, the encapsulation unit 610 can be configured to a single type of media into a streaming protocol's standard container format. The one or more segments can be unencrypted after encapsulation by the encapsulation unit 610 before the origin server 606 serves the one or more content segments to the CDN 604. Material transported over at least one of signal communication links existing at least one of between of the encapsulation unit 610 and the persistent storage 612, between the encapsulation unit 610 and the requestor 614, between the persistent storage 612 and the uploader 616, between the uploader 616 and the requestor 614, or between the requester 614 and the transcoder 618 can be in a common transcoder output format, such as H.264 format as adapted from an incoming signal by a segmenter. Note that the segmenter can also be configured to device an incoming material into a plurality of segments. Material transported over at least one of signal communication links existing at least one of between the transcoder 618 and the input service 620 or between the input service 620 and the input device 622 can be in a format dependent on a reception equipment. In some embodiments, the requester 614 can include, be a part of, or is a segmenter, as disclosed herein.

The input service 620 is an adapter for any kind of an input stream, allowing the transcoder 618 to request parts of the input stream through a common interface. For example, the input stream can operate as, include, or be anything from Moving Picture Experts Group-Transport Stream (MPEG-TS) delivered through a satellite to HTTP Live Streaming (HLS) delivered over a network, such as Internet. However, other technologies are possible, whether additionally or alternatively, such as Moving Picture Experts Group-Dynamic Adaptive Streaming over HTTP (MPEG-DASH), Smooth Streaming, or others. Additionally or alternatively, the input service 620 or the input device 622 can operate as, include, or be different types of reception equipment, such as reception via satellite or via fiber optic cable.

The transcoder 618 can receive an unmodified range of bytes from the input service 620. The transcoder 618 can then de-encapsulate the requested elementary stream, decode the requested elementary stream into a plurality of raw frames, apply one or more filters, such as a deinterlace filter or a scale filter, and encode the raw frames to a requested encoding. Note that local in-memory caching can be performed after decoding and/or filtering as the decoding and/or the filtering are resource intensive processing operations.

The requester 614 is an optional component that can be left out when delivering a live stream lacks any kind of a catch-up ability. However, for catch-up enabled streams and for VOD, the requester 614 can be responsible for calculating many, most, or all predictable segments and qualities based on a configuration. The requester 614 can request the segments or the qualities from transcoder 618 and storing the transcoded segments or the transcoded qualities to the persistent storage 612.

Resultantly, a whole transcoding process, which involves one or more operations of the origin server 606, the encryption unit 608, the encapsulation unit 610, is initiated and driven by a request to the origin server 606 to deliver a segment, rather than the whole transcoding process being driven by the fact that material is available in the input device 622. Consequently, unless the origin server 606 receives a request for a segment from at least one of the client device 602 or the requester 614 no transcoding takes place and no storage is needed. For example, when the client device 602 requests a segment over the CDN 604 from the origin server 606, then such operations imply that an end user desires to view a live program and therefore transcoding will start to produce one or more segments for that live program. Likewise, for example, when the requester 614 requests a segment from the input service 620, then such operations imply that the architecture 600 supports some form of recordation, where the requester 614 according to one or more rules, such as given a program start and a program end, can request segments and store the requested segments for later use, such as retrieval by an end user device, for instance the client device 602.

In some embodiments, the present disclosure enables a use of costly transcoding techniques usually associated with VOD media transcoding also for live content where a real-time aspect of the content is important. Such configuration includes transcoding of large number of output qualities and for example two pass encoding, which includes a first pass where a video is analyzed and a second pass where an output is produced with a help of the first pass. Note that multiple second pass encodings can share a result of the first pass.

In some embodiments, the present disclosure enables on demand transcoding of both live and VOD media as the pull model allows transcoding to happen when an end user is actually watching a stream. For example, content, which has time shifting disabled or disallowed, can be delivered to end users, thereby eliminating any storage costs. Server resources can also be saved as transcoding is conditioned on stream consumption, i.e., nothing is transcoded if nobody is consuming the content stream.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The present disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although preferred embodiments have been depicted and described in detail herein, it will be apparent to those skilled in the relevant art that various modifications, additions, substitutions and the like can be made without departing from the spirit of the disclosure, and these are, therefore, considered to be within the scope of the disclosure, as defined in the following claims.

What is claimed is:

1. A method comprising:
receiving, via an input service running on a server, a transcoding request from a client, the transcoding request requesting a segment of digital content, the transcoding request containing a start time of the segment and a duration of the segment;
requesting, via the input service, the segment from a source based on the transcoding request;
receiving, via the input service, the segment and metadata from the source based on the requesting, the metadata being related to the start time and the duration;
transcoding, via the input service, the segment based on the metadata in the transcoder service; and
sending, via the input service, the segment from the transcoder service to the client based on the transcoding.

2. The method of claim 1, wherein the segment is cached immediately before retrieval via the input service.

3. The method of claim 1, wherein the segment is obtained from at least one of a file or a stream of the content.

4. The method of claim 1, further comprising:
caching, via the server, an intermediate result of the transcoding; and
providing, via the server, the intermediate result for reuse.

5. The method of claim 1, further comprising:
forming, via the server, a filter chain based on the segment and an output configuration, the transcoding request contains the output configuration.

6. The method of claim 1, wherein the transcoding request is received over a content delivery network.

7. The method of claim 1, further comprising:
receiving, via the server, a message informative of a content player being stopped on the client; and
halting, via the server, the transcoding based on the message.

8. The method of claim 1, wherein the transcoding is initiated by the transcoding request, wherein the content is a live streaming content.

9. The method of claim 1, wherein the segment is a first segment, and further comprising:
providing, via the server, a second segment when the first segment is unable to be served for consumption, wherein the second segment comprises a pre-encoded filler information,
replacing, via the server, the first segment with the second segment.

10. The method of claim 9, wherein the pre-encoded filler information is informative of a reason or a problem why the first segment is unable to be served for consumption.

11. A system comprising:
a server configured to:
receive, via an input service, a transcoding request from a client, the transcoding request requesting a segment of digital content, the transcoding request containing a start time of the segment and a duration of the segment;
request, via the input service, the segment from a source based on the transcoding request;
receive, via the input service, the segment and metadata from the source based on the requesting, the metadata being related to the start time and the duration;
transcode, via the input service, the segment based on the metadata in the transcoder service; and
send, via the input service, the segment from the transcoder service to the client based on the transcoding.

12. The system of claim 11, wherein the segment is cached immediately before retrieval via the input service.

13. The system of claim 11, wherein the segment is obtained from at least one of a file or a stream of the content.

14. The system of claim 11, wherein the server is configured to:
cache an intermediate result of the transcoding; and
provide the intermediate result for reuse.

15. The system of claim 11, wherein the server is configured to:
form a filter chain based on the segment and an output configuration, the transcoding request contains the output configuration.

16. The system of claim 11, wherein the transcoding request is received over a content delivery network.

17. The system of claim 11, wherein the server is configured to:
receive a message informative of a content player being stopped on the client; and
halt the transcoding based on the message.

18. The system of claim 11, wherein the transcoding is initiated by the transcoding request, wherein the content is a live streaming content.

19. The system of claim 11, wherein the segment is a first segment, and the server is configured to:
provide a second segment when the first segment is unable to be served for consumption, wherein the second segment comprises a pre-encoded filler information,
replace the first segment with the second segment.

20. The system of claim 19, wherein the pre-encoded filler information is informative of a reason or a problem why the first segment is unable to be served for consumption.
